(19) United States
(12) Patent Application Publication
(10) Pub. No.: US 2018/0301103 A1
(43) Pub. Date: Oct. 18, 2018

(54) GOA CIRCUITS AND LIQUID CRYSTAL DISPLAYS

(71) Applicant: Shenzhen China Star Optoelectronics Technology Co., Ltd., Shenzhen, Guangdong (CN)

(72) Inventors: Wenying LI, Shenzhen, Guangdong (CN); Yi-Fang CHOU, Shenzhen, Guangdong (CN); Po-Jen CHIANG, Shenzhen, Guangdong (CN)

(73) Assignee: Shenzhen China Star Optoelectronics Technology Co., Ltd., Shenzhen, Guangdong (CN)

(21) Appl. No.: 15/524,266

(22) PCT Filed: Apr. 10, 2017
(86) PCT No.: PCT/CN2017/079910

§ 371 Date: May 3, 2017

(30) Foreign Application Priority Data
Mar. 7, 2017 (CN) 201710131499.3

(51) Int. Cl. G09G 3/36

(52) U.S. Cl. CPC G09G 3/3677; G09G 2310/08; G09G 2310/06; G09G 2330/08

(57) ABSTRACT

A gate driver on array (GOA) circuit and a display device are provided. The GOA circuit includes a plurality of cascaded GOA units and at least one repair GOA unit. A first repair line, a second repair line, and the third repair line utilized by the repair GOA unit are respectively connected with a signal output line of a corresponding GOA unit at a previous level of an abnormal GOA unit of the cascaded GOA units, a signal output line of the corresponding GOA unit at a next level of the abnormal GOA unit, and a signal output line of the abnormal GOA unit. Besides the original cascaded GOA units, by adding the repair GOA units to replace the abnormal GOA unit, which can make the whole GOA circuit to be operated normally, improving the yield of the product.

### BACKGROUND OF THE INVENTION

### 1. Field of the Invention

The present disclosure relates to liquid crystal display technology, and more particularly to a gate driver on array (GOA) and a display device.

### 2. Discussion of the Related Art

In the active display, the driving for the horizontal scan lines of the display panel is mainly achieved by an external integral chip (IC) connected from the outside of the panel. The external IC uses driving signals to sequentially control charge and discharge of the horizontal scan lines at each level connected with each pixel at each level. The gate driver on array (GOA) technology can be utilized in the original process of the display panel to manufacture the driving circuit for driving the horizontal scan lines on the substrate at a rim of the pixel display area, which replaces the external IC to drive the horizontal scan lines. The GOA technology can simplify the manufacture process of the display panel, and spare the IC bonding process on the direction of the horizontal scan line. It can increase the productivity and reduce the cost of product, as well as improve the integration of the display panel to make itself more suitable for producing the narrow border or no border display products.

The conventional GOA circuit normally includes a plurality of cascaded GOA units. The cascaded GOA units at each level correspond to a horizontal scan line at one level. Usually the GOA units at the first four levels is controlled by the external input low-frequency signals to turn on or off. The remaining GOA units are controlled by the corresponding GOA unit at a previous level and the corresponding GOA unit at a next level to turn on and turn off. Therefore, in the GOA circuit, the GOA unit at each level has a close connection with the corresponding GOA unit at a previous level and the corresponding GOA unit at a next level. When the GOA unit at a certain level in the GOA circuit has a malfunction, the other GOA units having a relation with the abnormal GOA unit also have malfunction, which results that the whole display panel cannot be operated normally and be deemed as worthless, so as to decrease the yield of the product.

### SUMMARY

The present disclosure relates to a gate driver on array (GOA) circuit and a display device. The GOA circuit of the present disclosure has the repair ability, so as to improve yield of the product.

In one aspect, a display device is provided. The display device includes a display panel and a driving control board coupled to the display panel. The display panel includes a pixel display area and a gate driver on array (GOA) circuit, the GOA circuit being disposed at a rim of the pixel display area. The GOA circuit includes a plurality of cascaded GOA units and at least one repair GOA unit. The at least one repair GOA unit includes a pull-up control circuit, a pull-down circuit and a pull-up circuit.

Wherein when an abnormal GOA unit is detected in the cascaded GOA units, an input end of the pull-up control circuit is configured for connecting with a signal output line of a corresponding GOA unit at a previous level of the abnormal GOA unit, an input end of the pull-down circuit is configured for connecting with a signal output line of the corresponding GOA unit at a next level of the abnormal GOA unit, a signal output end of the pull-up circuit is configured for connecting with a signal output line of the abnormal GOA unit, such that the signal output line of the abnormal GOA unit outputs output signals of the pull-up circuit.

Wherein the input end of the pull-up control circuit, the input end of the pull-down circuit, and the signal output end of the pull-up circuit are respectively provided with a first repair line, a second repair line and a third repair line.

The first repair line, the second repair line and the third repair line are respectively crossed with the signal output lines of the cascaded GOA units at first intersections and are insulated from the signal output lines; and the first repair line, and second repair line and the third repair line are conducted with the abnormal GOA unit at the first intersection when the abnormal GOA unit exists in the cascaded GOA units

In another aspect, a gate driver on array (GOA) circuit is provided. The GOA circuit includes a plurality of cascaded GOA units and at least one repair GOA unit. The at least one repair GOA unit includes a pull-up control circuit, a pull-down circuit and a pull-up circuit.

Wherein an input end of the pull-up control circuit is provided with a first repair line, an input end of the pull-down circuit is provided with a second repair line, and a signal output end of the pull-up circuit is provided with a third repair line. The first repair line and the second repair line are respectively crossed with a signal output line of a corresponding GOA unit at a previous level of an abnormal GOA unit of the cascaded GOA units and a signal output line of the corresponding GOA unit at a next level of the abnormal GOA unit of the cascaded GOA units, the third repair line ae connected with a signal output line of the abnormal GOA unit, such that the signal output line of the abnormal GOA unit outputs signals outputted by the third repair line.

In another aspect, a gate driver on array (GOA) circuit is provided. The GOA circuit includes a plurality of cascaded GOA units and at least one repair GOA unit. The at least one repair GOA unit includes a pull-up control circuit, a pull-down circuit and a pull-up circuit.

Wherein when an abnormal GOA unit is detected in the cascaded GOA units, an input end of the pull-up control circuit is configured for connecting with a signal output line of a corresponding GOA unit at a previous level of the abnormal GOA unit, an input end of the pull-down circuit is configured for connecting with a signal output line of the corresponding GOA unit at a next level of the abnormal GOA unit, a signal output end of the pull-up circuit is configured for connecting with a signal output line of the abnormal GOA unit, such that the signal output line of the abnormal GOA unit outputs output signals of the pull-up circuit.

In view of the above, the GOA of the disclosure includes a plurality of cascaded GOA units and at least one repair GOA unit. A first repair line, a second repair line, and the third repair line utilized by the repair GOA unit are respectively connected with a signal output line of a corresponding GOA unit at a previous level of an abnormal GOA unit of the cascaded GOA units, a signal output line of the corresponding GOA unit at a next level of the abnormal GOA unit of the cascaded GOA units, and a signal output line of the abnormal GOA unit. The first repair line and the second repair line utilized by the repair GOA unit of the disclosure are configured for providing the same turn-on signals and the same turn-off signals of the abnormal GOA unit, such that the output signals of the third repair line of the repair GOA unit are the same as that of the abnormal GOA unit, so as to make that the signal output line of the abnormal GOA unit outputs the signals outputted by the third repair line. Besides the original cascaded GOA units, by adding the repair GOA units to replace the abnormal GOA unit, which can make the whole GOA circuit to be operated normally, improving the yield of the product. The disclosure also provides a display device utilizing the GOA circuit of the disclosure.

### BRIEF DESCRIPTION OF THE DRAWINGS

FIG. 1 is a schematic view of the GOA units at each level in the conventional GOA circuit.

FIG. 2 is a schematic view of the conventional GOA circuit.

FIG. 3 is a schematic view of the GOA circuit in accordance with one embodiment of the present disclosure.

FIG. 4 is a schematic view of the GOA circuit in which the abnormal GOA unit is replaced by the repair GOA unit in accordance with one embodiment of the present disclosure.

FIG. 5 is a schematic view of the display device in accordance with one embodiment of the present disclosure.

### DETAILED DESCRIPTION OF THE EMBODIMENTS

Among the specification and the scope of subsequent terms are used to refer to specific components. Those of skill in the art will appreciate that manufacturers may use different terms to refer to the same components. The patent specification and subsequent differences in the name of the range is not to be used as a way to distinguish between the components, but with differences in the functional components as distinguished benchmarks. Embodiments of the invention will now be described more fully hereinafter with reference to the accompanying drawings, in which embodiments of the invention are shown.

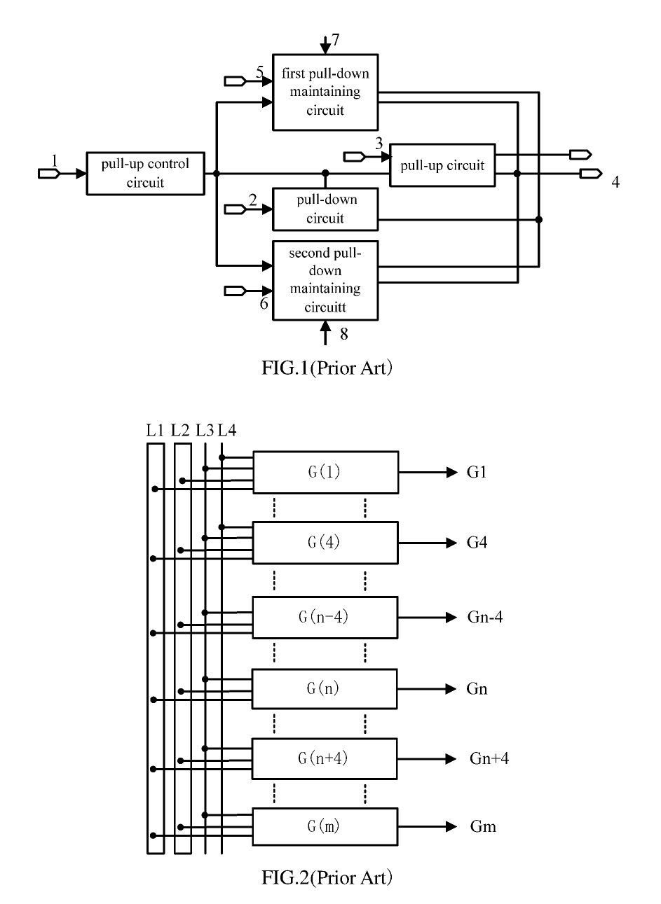

FIG. 1 is a schematic view of the gate driver on array (GOA) units at each level in the conventional GOA circuit, and FIG. 2 is a schematic view of the conventional GOA circuit. As shown in FIG. 1, the circuit configuration of the GOA units at each level in the conventional GOA circuit is the same. The GOA unit at each level includes a pull-up circuit 300, a pull-up control circuit 100, a pull-down circuit 200, a first pull-down maintaining circuit 400, a second pull-down maintaining circuit 500 and a Boost capacitor (not shown). Correspondingly, a first input end 1 of the pull-up control circuit 100 is connected with a signal output end of a corresponding GOA unit at a previous level of a GOA unit. A fifth input end 5 and a seventh input end 7 of the first pull-down maintaining circuit 400 are respectively input by low-frequency signals and direct currents. A third input end 3 of the pull-up circuit 300 is input by high-frequency clock signals. A second input end 2 of the pull-down circuit 200 is connected with a signal output end of a corresponding GOA at a next level of the GOA unit. Wherein the pull-up circuit 300 is configured for outputting the high-frequency clock signals as gate signals. The pull-up control circuit 100 is configured for controlling the turn-on period of the pull-up circuit 300, and is normally connected to the gate signals transmitted by the corresponding GOA unit at a previous level. The pull-down circuit 200 is configured for pull down the gate signals as low potential level. The first pull-down maintaining circuit 400 and the second pull-down maintaining circuit 500 are operated alternatively, both of which are configured for maintaining the gate output signals and the gate signals of the pull-down circuit 200 as a turn-off state, that is, low-potential state. The boost capacitor is configured for lifting the gate signals at second time. Finally, the pull-up circuit 300 outputs gate driving signals at the current level to drive horizontal scanning line.

As such, it can be seen that the GOA unit at each level uses the pull-up control circuit 100 and the pull-down circuit 200 at the current level such that the GOA unit at the current level has a close connection with the corresponding GOA unit at the previous level and the corresponding GOA unit at the next level.

As shown in FIG. 2, the conventional GOA circuit includes a plurality of cascaded GOA units G(1), G(2)...G(m) at the m levels. Each of the cascaded GOA units is respectively connected with a horizontal scan line at one level. In the GOA units G(1), G(2)...G(m), the GOA units at the first four levels utilize high-frequency clock signals, low-frequency signals, direct currents, and turn-on signals, respectively, outputted by a plurality of high-frequency clock signal transmitting lines L1, low-frequency signal transmitting lines L2, direct-current transmitting lines L3, and turn-on signal transmitting lines L4 to drive. The other GOA units utilize the corresponding GOA unit at the previous level of the GOA unit at the current level and the corresponding GOA unit at the next level of the GOA unit at the current level to turn on and pull down. The GOA unit is what the corresponding GOA unit at which previous level is and what the corresponding GOA unit at which next level is, it can be adjusted according to the requirement. Usually it is at the previous fourth level and at the next fourth level.

It can be seen from the schematic view of the conventional GOA circuit that when a GOA unit at a certain level in the GOA circuit has a malfunction, it can result in that the other GOA units at levels relating to the GOA unit at the certain level also have malfunction, which makes the whole GOA circuit cannot be operated normally, lowering the yield of the products.

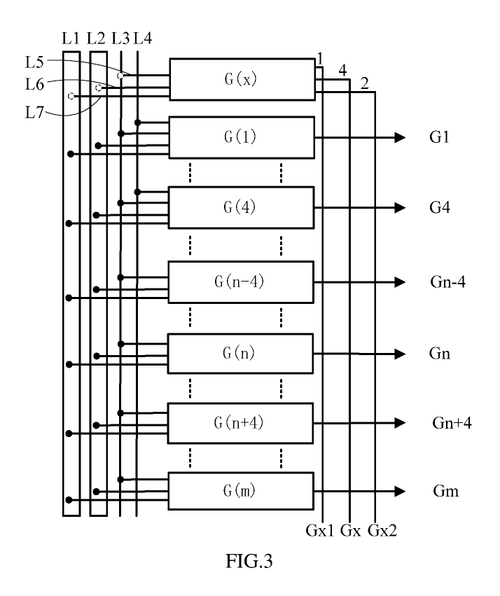

Referring to FIG. 3, FIG. 3 is a schematic view of the GOA circuit in accordance with one embodiment. The GOA circuit includes a plurality of cascaded GOA units G(1), G(2), . . . G(m) and at least one repair GOA unit G(x). The structure of the repair GOA unit G(x) is the same as that of any one of the cascaded GOA units G(1), G(2), . . . G(m). Please refer to the schematic view of the GOA unit shown in FIG. 1.

In the embodiment, when an abnormal GOA unit is detected in the cascaded GOA units G(1), G(2), . . . G(x), a first input end 1 of the pull-up control circuit 100 in the repair GOA unit G(x) is configured for connecting with a signal output line of a corresponding GOA unit at a previous level of the abnormal GOA unit, an input end 2 of the pull-down circuit 200 is configured for connecting with a signal output line of the corresponding GOA unit at a next level of the abnormal GOA unit, a signal output end 4 of the pull-up circuit 300 is configured for connecting with a signal output line of the abnormal GOA unit, such that the signal output line of the abnormal GOA unit outputs signals outputted by a third repair line.

The GOA circuit in the embodiment uses that the output signals of the corresponding GOA unit at the previous level for driving the pull-up control circuit of the abnormal GOA unit and the output signals of the corresponding GOA unit at the next level for driving the pull-down circuit of the abnormal GOA unit are respectively transmitted to the pull-up control circuit and the pull-down circuit of the repair GOA unit, such that the output signals of the repair GOA unit are the same as the output signals of the abnormal GOA unit while it is operated normally, so as to replace the abnormal GOA unit by the repair GOA unit. Therefore, the whole GOA circuit cannot be discarded as worthless because of the abnormal GOA unit, improving the yield of the products.

Specifically, as shown in FIG. 3, the first input end 1 of the pull-up control circuit 100 and the second input end 2 of the pull-down circuit 200 in the repair GOA unit G(x) are respectively provided with a first repair line Gx1 and a second repair line Gx2, and the signal output end 4 of the pull-up circuit 300 is provided with a third repair line Gx. The first repair line Gx1, the second repair line Gx2 and the third repair line Gx are respectively crossed with the signal output lines of the cascaded GOA units G(1), G(2) . . . G(m) at first intersections and are insulated from the signal output lines. When the abnormal GOA unit exists in the cascaded GOA units G(1), G(2) . . . G(m), the first repair line Gx1, and second repair line Gx2 and the third repair line Gx are conducted with the abnormal GOA unit at the first intersection.

In the embodiment, there are several ways of making the first repair line, the second repair line and the third repair line are respectively crossed with the signal output lines of the cascaded GOA units at first intersections and are insulated from the signal output lines. For example, the first repair line, the second repair line and the third repair line can be disposed on the same layer, and the first repair line, the second repair line and the third repair line are separated from the signal output lines of the cascaded GOA units by the insulation layer, realizing that the first repair line, the second repair line and the third repair line are respectively crossed with the signal output lines of the cascaded GOA units at first intersections and are insulated from the signal output lines. Besides, the first repair line, the second repair line and the third repair line can be also disposed on different layers, meeting the requirement that they are not conducted between the first repair line, the second repair line and the third repair line, and the first repair line, the second repair line and the third repair line are respectively crossed with the signal output lines of the cascaded GOA units at first intersections and are insulated from the signal output lines.

In the embodiment, the way that the first repair line, and second repair line and the third repair line are conducted with the abnormal GOA unit at the first intersection is not limited. The method of laser welding is used to make the first repair line, and second repair line and the third repair line are conducted with the abnormal GOA unit at the first intersection when the abnormal GOA unit exists in the cascaded GOA units.

Furthermore, it does not need to describe that the high-frequency clock signal transmitting lines, the low-frequency signal transmitting lines, and the direct-current transmitting lines of the repair GOA unit G(x) are the same as the high-frequency clock signal transmitting lines L1, the low-frequency signal transmitting lines L2, and the direct-current transmitting lines L3. A high-frequency clock signal input end L7, a low-frequency signal input end L6, and a direct-current input end L5 of the repair GOA unit G(x) are respectively crossed with the high-frequency clock signal transmitting lines L1, the low-frequency signal transmitting lines L2, and the direct-current transmitting lines L3 of the cascaded GOA units G(1), G(2) . . . G(m) at second intersections, and are insulated from the high-frequency clock signal transmitting lines L1, the low-frequency signal transmitting lines L2, and the direct-current transmitting lines L3 while the abnormal GOA unit does not exist in the cascaded GOA units G(1), G(2) . . . G(m). The method of making the high-frequency clock signal input end L7, the low-frequency signal input end L6, and the direct-current input end L5 of the repair GOA unit G(x) are respectively crossed with the high-frequency clock signal transmitting lines L1, the low-frequency signal transmitting lines L2, and the direct-current transmitting lines L3 of the cascaded GOA units G(1), G(2) . . . G(m) at the second intersections, and are insulated from the high-frequency clock signal transmitting lines L1, the low-frequency signal transmitting lines L2, and the direct-current transmitting lines L3 is the same method of making the first repair line, the second repair line and the third repair line are respectively crossed with the signal output lines of the cascaded GOA units at the first intersections and are insulated from the signal output lines. When the abnormal GOA unit exists in the cascaded GOA units G(1), G(2) . . . G(m), the high-frequency clock signal input end L7, the low-frequency signal input end L6, and the direct-current input end L5 of the repair GOA unit G(x) are respectively conducted at the second intersections. The laser welding method can be also utilized here.

When an abnormal GOA unit is detected in the cascaded GOA units, the high-frequency clock signal transmitting lines, the low-frequency signal transmitting lines, and the direct-current transmitting lines of the repair GOA unit are respectively conducted with the high-frequency clock signal transmitting lines, the low-frequency signal transmitting lines, and the direct-current transmitting lines, making that the output signals of the repair GOA unit is higher in similarity with the output signals of the abnormal GOA unit while it is operated normally, preferably replacing the abnormal GOA unit with the repair GOA unit. However, it needs to take a certain repair time during the welding process.

Besides, when the abnormal GOA unit does not exist in the cascaded GOA units G(1), G(2) . . . G(m), the high-frequency clock signal input end L7, the low-frequency signal input end L6, and the direct-current input end L5 of the repair GOA unit G(x) can be also, respectively, directly conducted with the high-frequency clock signal transmitting lines L1, the low-frequency signal transmitting lines L2, and the direct-current transmitting lines L3 of the cascaded GOA units G(1), G(2) . . . G(m). It can reduce the welding process, and shorten the repairing time by the mean of the connecting method. However, it could be increase the capacitors of the repair GOA unit, making the output signals of the repair GOA unit is little different from the output signals of the abnormal GOA unit while it is operated normally.

The number of the repair GOA units is not limited specifically. The number of the repair GOA units can be adjusted according to the space of the display panel. The more numbers the repair GOA units have, the better repairing ability the GOA circuit has. However, more repair GOA units could also occupy the more space of the display panel.

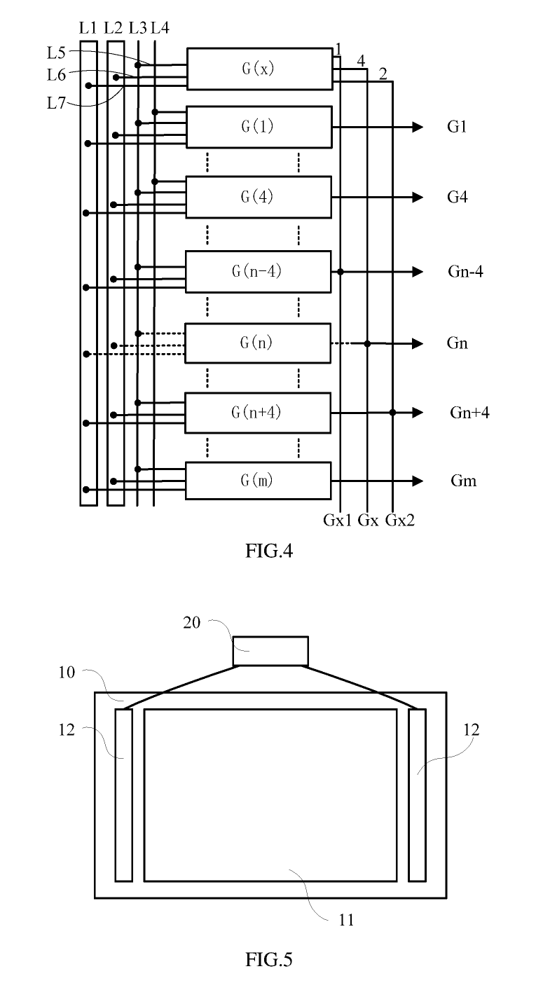

Referring to FIG. 4, FIG. 4 is a schematic view of the GOA circuit in which the abnormal GOA unit is replaced by the repair GOA unit in accordance with one embodiment. In the embodiment, it is assumed that the abnormal GOA unit is the GOA unit at the n-th level, the pull-up control circuit of the GOA unit at the n-th level is driven by the GOA unit at the (n−4)-th level, and the pull-down circuit of the GOA unit at the n-th level is driven by the GOA unit at the (n+4)-th level. As shown in FIG. 4, a first input end 1 of the pull-up control circuit 100 in the repair GOA unit G(x) is provided with a first repair line Gx1, a second input end 2 of the pull-down circuit 200 is provided with a second repair line Gx2, and a signal output end 4 of the pull-up circuit 300 is provided with a third repair line Gx. When an abnormal GOA unit at the n-th level is detected in the cascaded GOA units G(1), G(2) . . . G(m), the first repair line Gx1 and the second repair line Gx2 are respectively connected with a signal output line Gn−4 of the GOA unit at the (n−4)-th level and a signal output line Gn+4 of the GOA unit at the (n+4)-the level, and the third repair line Gx is connected with a signal output line Gn of the GOA unit at the n-th level, such that the signal output line Gn of the GOA unit at the n-th level outputs signals outputted by the third repair line Gx of the repair GOA unit G(x).

At this moment, a high-frequency clock signal input end, a low-frequency signal input end, and a direct-current input end of the abnormal GOA unit at the n-th level are respectively, totally or partly disconnected with the high-frequency clock signal transmitting lines L1, the low-frequency signal transmitting lines L2, and the direct-current transmitting lines L3. Furthermore, an output end of the pull-up circuit in the abnormal GOA unit at the n-th level can be also disconnected with the signal output limes. That is, the abnormal GOA unit is not cascaded with the other GOA units. A welding method is utilized, such that the first repair line Gx1, the second repair line Gx2, and the third repair line Gx are respectively connected with the signal output line Gn−4 of the GOA unit at the (n−4)-th level, the signal output line Gn+4 of the GOA unit at the (n+4)-th level, and the signal output line Gn of the GOA unit at the n-th level at the intersections. The welding method can be a laser welding method.

At this moment, the high-frequency clock signal input end L7, the low-frequency signal input end L6, and the direct-current input end L5 of the repair GOA unit Gx are respectively conducted with the high-frequency clock signal transmitting lines L1, the low-frequency signal transmitting lines L2, and direct-current transmitting lines L3 of the cascaded GOA units G(1), G(2) . . . G(m).

Referring to FIG. 5, FIG. 5 is a schematic view of the display device in accordance with one embodiment. The display device includes a display panel 10 and a driving control board 20. The driving control board 20 is coupled to the display panel. The display panel 10 includes a pixel display area 11 and a GOA circuit 12. The driving control board 20 is configured for providing driving signals and control signals. The GOA circuit 12 is disposed at a rim of the pixel display area 11, and is configured for driving the horizontal scan lines within the pixel display area 11. The GOA circuit 12 can be disposed on a left side or a right side of the pixel display area 11. The GOA circuit 12 can be also disposed on the left side and the right side of the pixel display area 11.

When the abnormal GOA unit does not exist in the GOA circuit 12, the structure of the GOA circuit 12 is the GOA circuit as shown in FIG. 3. When there is an abnormal GOA unit at a certain level in the GOA circuit 12, the abnormal GOA unit will be replaced by the repair GOA unit, forming the GOA circuit as shown in FIG. 4.

The display device in the embodiment utilizes the GOA circuit of FIG. 3, which has the repair ability when the GOA unit at a certain level is abnormal in the GOA circuit 12, improving the yield of the GOA circuit 12 products and improving the yield of the display device products, so as to increase the operation stability of the display devices.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display device, comprising:
a display panel and a driving control board coupled to the display panel, the display panel comprising a pixel display area and a gate driver on array (GOA) circuit, the GOA circuit being disposed at a rim of the pixel display area, the GOA circuit comprising a plurality of cascaded GOA units and at least one repair GOA unit, the at least one repair GOA unit comprising a pull-up control circuit, a pull-down circuit and a pull-up circuit;
wherein when an abnormal GOA unit is detected in the cascaded GOA units, an input end of the pull-up control circuit is configured for connecting with a signal output line of a corresponding GOA unit at a previous level of the abnormal GOA unit, an input end of the pull-down circuit is configured for connecting with a signal output line of the corresponding GOA unit at a next level of the abnormal GOA unit, a signal output end of the pull-up circuit is configured for connecting with a signal output line of the abnormal GOA unit, such that the signal output line of the abnormal GOA unit outputs output signals of the pull-up circuit; and
wherein the input end of the pull-up control circuit, the input end of the pull-down circuit, and the signal output end of the pull-up circuit are respectively provided with a first repair line, a second repair line and a third repair line;
the first repair line, the second repair line and the third repair line are respectively crossed with the signal output lines of the cascaded GOA units at first intersections and are insulated from the signal output lines; and the first repair line, and second repair line and the third repair line are conducted with the abnormal GOA unit at the first intersection when the abnormal GOA unit exists in the cascaded GOA units.

2. The display device as claimed in claim 1, wherein the GOA circuit is disposed on a left side and/or a right side of the pixel display area.

3. The display device as claimed in claim 1, wherein a high-frequency clock signal input end, a low-frequency signal input end, and a direct-current input end of the at least one repair GOA unit are respectively crossed with high-frequency clock signal transmitting lines, low-frequency signal transmitting lines, and direct-current transmitting lines of the cascaded GOA units at second intersections, and are insulated from the high-frequency clock signal transmitting lines, the low-frequency signal transmitting lines, and the direct-current transmitting lines, and the second intersections are conducted when the abnormal GOA unit exists in the cascaded GOA units.

4. The display device as claimed in claim 1, wherein a high-frequency clock signal input end, a low-frequency signal input end, and a direct-current input end of the at least one repair GOA unit are respectively conducted with high-frequency clock signal transmitting lines, low-frequency signal transmitting lines, and direct-current transmitting lines of the cascaded GOA units.

5. A gate driver on array (GOA) circuit, comprising:
a plurality of cascaded GOA units and at least one repair GOA unit, the at least one repair GOA unit comprising a pull-up control circuit, a pull-down circuit and a pull-up circuit;
wherein an input end of the pull-up control circuit is provided with a first repair line, an input end of the pull-down circuit is provided with a second repair line, and a signal output end of the pull-up circuit is provided with a third repair line;
the first repair line and the second repair line are respectively crossed with a signal output line of a corresponding GOA unit at a previous level of an abnormal GOA unit of the cascaded GOA units and a signal output line of the corresponding GOA unit at a next level of the abnormal GOA unit of the cascaded GOA units, the third repair line ae connected with a signal output line of the abnormal GOA unit, such that the signal output line of the abnormal GOA unit outputs signals outputted by the third repair line.

6. The GOA circuit as claimed in claim 5, wherein the first repair line, the second repair line, and the third repair line are respectively crossed with signal output lines of the cascaded GOA units at intersections;
wherein the first repair line, the second repair line, and the third repair line are respectively connected with the signal output line of the corresponding GOA unit at the previous level of the abnormal GOA unit, the signal output line of the corresponding GOA unit at the next level of the abnormal GOA unit, and the signal output line of the abnormal GOA unit at the intersections; and the first repair line, the second repair line, and the third repair line is insulated from signal output lines of the remaining GOA units of the cascaded GOA units.

7. The GOA circuit as claimed in claim 6, wherein a welding method is utilized, such that the first repair line, the second repair line, and the third repair line are respectively connected with the signal output line of the corresponding GOA unit at the previous level of the abnormal GOA unit, the signal output line of the corresponding GOA unit at the next level of the abnormal GOA unit, and the signal output line of the abnormal GOA unit at the intersections.

8. The GOA circuit as claimed in claim 5, wherein a high-frequency clock signal input end, a low-frequency signal input end, and a direct-current input end of the at least one repair GOA unit are respectively conducted with high-frequency clock signal transmitting lines, low-frequency signal transmitting lines, and direct-current transmitting lines of the cascaded GOA units.

9. A gate driver on array (GOA) circuit, comprising:
a plurality of cascaded GOA units and at least one repair GOA unit, the at least one repair GOA unit comprising a pull-up control circuit, a pull-down circuit and a pull-up circuit;
wherein when an abnormal GOA unit is detected in the cascaded GOA units, an input end of the pull-up control circuit is configured for connecting with a signal output line of a corresponding GOA unit at a previous level of the abnormal GOA unit, an input end of the pull-down circuit is configured for connecting with a signal output line of the corresponding GOA unit at a next level of the abnormal GOA unit, a signal output end of the pull-up circuit is configured for connecting with a signal output line of the abnormal GOA unit, such that the signal output line of the abnormal GOA unit outputs output signals of the pull-up circuit.

10. The GOA circuit as claimed in claim 9, wherein the input end of the pull-up control circuit, the input end of the pull-down circuit, and the signal output end of the pull-up circuit are respectively provided with a first repair line, a second repair line and a third line; and
the first repair line, the second repair line and the third repair line are respectively crossed with signal output lines of the cascaded GOA units at first intersections, and are insulated from the signal output lines; and the first repair line, and second repair line and the third repair line are conducted with the abnormal GOA unit at the first intersection when the abnormal GOA unit exists in the cascaded GOA units.

11. The GOA circuit as claimed in claim 9, wherein a high-frequency clock signal input end, a low-frequency signal input end, and a direct-current input end of the at least one repair GOA unit are respectively crossed with high-frequency clock signal transmitting lines, low-frequency signal transmitting lines, and direct-current transmitting lines of the cascaded GOA unit at second intersections, and are insulated from the high-frequency clock signal transmitting lines, the low-frequency signal transmitting lines, and the direct-current transmitting lines; and the high-frequency clock signal input end, the low-frequency signal input end, and the second intersections are conducted when the abnormal GOA unit exists in the cascaded GOA units.

12. The GOA circuit as claimed in claim 9, wherein a high-frequency clock signal input end, a low-frequency signal input end, and a direct-current input end of the at least one repair GOA unit are respectively conducted with high-frequency clock signal transmitting lines, low-frequency signal transmitting lines, and direct-current transmitting lines of the cascaded GOA units.
